(19) United States
(12) Patent Application Publication
(10) Pub. No.: US 2026/0314718 A1
(43) Pub. Date: Oct. 15, 2026

(54) Cooling Garment

(71) Applicant: Shenzhen Chuangbian E-commerce Trading Co., Ltd., Shenzhen (CN)

(72) Inventor: Jinshun Zhou, Shenzhen (CN)

(21) Appl. No.: 19/684,237

(22) Filed: May 21, 2026

(30) Foreign Application Priority Data
Mar. 4, 2026 (CN) 202620260776.5
Mar. 4, 2026 (CN) 202620260777.X

(51) Int. Cl. A41D 13/005; A41D 1/04; A41D 13/002

(52) U.S. Cl. CPC A41D 13/0053; A41D 1/04; A41D 13/0025

(57) ABSTRACT

A cooling garment includes a garment body and a first cooling device. The first cooling device includes a water collecting portion, a cooling flow channel, and a pumping device. The water collecting portion is configured to contain a cooling liquid. The cooling flow channel is configured for the cooling liquid to flow through. The pumping device communicates the water collecting portion and the cooling flow channel, and the pumping device is configured to promote the cooling liquid to circulate along a path passing through the water collecting portion and the cooling flow channel. The cooling flow channel is formed on the garment body by pressing.

### CROSS REFERENCE TO RELATED APPLICATIONS

The present disclosure claims the priority of Chinese Patent Application No. 202620260776.5 filed on Mar. 4, 2026 before CNIPA, and claims the priority of Chinese Patent Application No. 202620260777.X filed on Mar. 4, 2026 before CNIPA. All the above are hereby incorporated by reference in their entirety.

### FIELD

The present disclosure relates to the field of cooling garments, and in particular to a cooling garment capable of improving cooling effect.

### BACKGROUND

As a functional garment for dissipating heat and cooling a wearer, a cooling garment can effectively prevent heat stress reactions in high-temperature environments, ensure physiological safety of the wearer, and improve work comfort, thereby significantly enhancing work efficiency and operational continuity. It is widely used in high-temperature work fields such as construction, electric power, and smelting.

However, cooling garments currently on the market mostly employ air-cooling technology, relying on built-in fans to accelerate air flow to enhance sweat evaporation rate, thereby taking body surface heat away and achieving a cooling effect. Nevertheless, in environments such as high temperature or no wind, such cooling garments have a poor cooling effect and struggle to cool down quickly and efficiently, greatly limiting an application of the cooling garments.

### SUMMARY

To overcome deficiencies of the related art, an objective of the present disclosure is to provide a cooling garment. By means of a water collecting portion containing a cooling liquid and a pumping device promoting circulation of the cooling liquid along a path passing through the water collecting portion and a cooling flow channel, more heat can be quickly taken away during a process of the cooling liquid flowing through the cooling flow channel, thereby improving a cooling effect.

In a first aspect, the present disclosure provides a cooling garment, which adopts the following technical solution.

A cooling garment includes a garment body, a first cooling device, and a second cooling device. The first cooling device is arranged on the garment body and includes a water collecting portion, a cooling flow channel, and a pumping device. The water collecting portion is configured to contain a cooling liquid. The cooling flow channel is formed on the garment body by pressing and configured for the cooling liquid to flow through. The pumping device communicates the water collecting portion and the cooling flow channel, and the pumping device is configured to promote the cooling liquid to circulate along a path passing through the water collecting portion and the cooling flow channel. The second cooling device is arranged on the garment body and includes a refrigeration device and a housing. The refrigeration device is arranged in the housing and configured for cooling.

The second cooling device further includes a cold conducting member and a heat dissipation device. The housing includes a base, an exhaust cover, and a fixing ring. The exhaust cover covers the base, and a receiving cavity is formed between the exhaust cover and the base. The base is arranged with an embedding protrusion, the fixing ring sleeves an outer side of the exhaust cover, the fixing ring has a top peripheral edge, and the fixing ring is circumferentially arranged with a plurality of inner protrusions. A mounting groove for embedding the embedding protrusion is formed between the top peripheral edge and each of the plurality of inner protrusions. A passage region for the embedding protrusion to pass through is formed between each two adjacent inner protrusions of the plurality of inner protrusions. The heat dissipation device is arranged in the receiving cavity, one end of the refrigeration device is formed as a refrigerating end, and the other end of the refrigeration device is formed as a heat dissipating end. The heat dissipation device is cooperated with the heat dissipating end of the refrigeration device. The cold conducting member is cooperated with the refrigerating end of the refrigeration device. Each of the base and the fixing ring is formed with an air intake portion.

The base defines a through hole and an embedding groove, and the through hole is communicated with the receiving cavity. The refrigeration device is arranged in the through hole. The embedding groove is communicated with the through hole and extends through the base to an end of the base away from the exhaust cover. The cold conducting member is embedded in the embedding groove, and an end of the cold conducting member away from the refrigeration device is exposed from the base.

One of the exhaust cover and the base is circumferentially arranged with a plurality of engaging protrusions, and the other of the exhaust cover and the base circumferentially defines a plurality of slots. Each of the plurality of engaging protrusions is engaged in a respective one of the plurality of slots.

The refrigeration device includes a refrigeration sheet. The heat dissipation device includes a heat sink and a heat dissipation fan. The heat sink defines a cavity, and the heat dissipation fan is arranged in the cavity.

The heat sink includes a seat and a plurality of heat dissipation fins circumferentially arranged on the seat. The seat abuts against the heat dissipating end of the refrigeration device.

The cooling flow channel includes a liquid inlet end and a liquid outlet end. The liquid inlet end of the cooling flow channel is communicated with the pumping device, and the liquid outlet end of the cooling flow channel is communicated with the water collecting portion. The pumping device includes a water pump, a water inlet end of the water pump is communicated with the water collecting portion, and a water outlet end of the water pump is communicated with the liquid inlet end of the cooling flow channel.

The water inlet end of the water pump is arranged with a first connector configured to be connected with the water collecting portion. The water outlet end of the water pump is arranged with a second connector configured to be connected with the cooling flow channel.

The garment body includes a back piece, a left front piece, and a right front piece. An upper end of the left front piece is arranged on one side of the back piece, and an upper end of the right front piece is arranged on the other side of the back piece.

The cooling flow channel includes a water inlet flow channel and a first circulation flow channel. The water inlet flow channel is communicated with the pumping device. The water inlet flow channel is at least partially formed on the back piece, the first circulation flow channel is communicated with the water inlet flow channel, and the first circulation flow channel is at least partially formed on the left front piece.

The cooling flow channel is arranged with a flow uniforming module configured for the cooling liquid to flow past. The flow uniforming module includes a plurality of water inlet flow uniforming members. The plurality of water inlet flow uniforming members are arranged sequentially at intervals in the water inlet flow channel. At least one of the water inlet flow uniforming members has a circular cross-section. The cooling flow channel includes a water outlet flow channel and a second circulation flow channel. The water outlet flow channel is communicated with the water collecting portion. The water outlet flow channel is at least partially formed on the back piece, the second circulation flow channel is communicated with each of the first circulation flow channel and the water outlet flow channel, and the second circulation flow channel is at least partially formed on the right front piece.

The garment body further includes an accessory portion, and the cooling flow channel is at least partially formed on the accessory portion.

On a second aspect, the present disclosure provides another cooling garment, which adopts the following technical solution.

A cooling garment includes a garment body and a water-cooling device. The garment body includes a garment main body and a garment accessory. The water-cooling device includes a water collecting portion, a cooling flow channel, and a pumping device. The water collecting portion is configured to contain a cooling liquid. The pumping device is configured to promote the cooling liquid to circulate along a path passing through the water collecting portion and the cooling flow channel. The cooling flow channel includes a garment cooling flow channel and an accessory cooling flow channel. The garment cooling flow channel is formed on the garment main body by pressing, and the garment cooling flow channel is configured for the cooling liquid to flow through. The accessory cooling flow channel is formed on the garment accessory by pressing, and the accessory cooling flow channel is configured for the cooling liquid to flow through.

The garment accessory is a collar or a hat.

The garment accessory is a collar, and the collar includes a collar body and a shapeable inner support. The accessory cooling flow channel is formed on the collar body. The shapeable inner support is arranged on the collar body and is configured to deform under an external force to adjust a shape of the collar body.

The accessory cooling flow channel is communicated with a water outlet end of the pumping device. The garment cooling flow channel is communicated with each of the accessory cooling flow channel and the water collecting portion. The water collecting portion is communicated with a water inlet end of the pumping device.

The accessory cooling flow channel is communicated with a water outlet end of the pumping device via a first communication pipe segment. The accessory cooling flow channel is communicated with the garment cooling flow channel via a second communication pipe segment.

The pumping device includes a water pump. A water outlet end of the water pump is arranged with an outlet connector configured to be communicated with the first communication pipe segment. The second communication pipe segment is arranged with a water return connector configured to be communicated with the water collecting portion.

The garment main body includes a back piece, a left front piece, and a right front piece. An upper end of the left front piece is arranged on one side of the back piece, and an upper end of the right front piece is arranged on the other side of the back piece.

The garment cooling flow channel includes a water inlet flow channel and a first circulation flow channel. The water inlet flow channel is at least partially formed on the back piece, the first circulation flow channel is communicated with the water inlet flow channel, and the first circulation flow channel is at least partially formed on the left front piece.

The cooling flow channel is arranged with a flow uniforming module configured for the cooling liquid to flow past. The flow uniforming module includes a plurality of water inlet flow uniforming members. The plurality of water inlet flow uniforming members are arranged sequentially at intervals in the water inlet flow channel. At least one of the water inlet flow uniforming member has a circular cross-section. The garment cooling flow channel includes a water outlet flow channel and a second circulation flow channel. The water outlet flow channel is communicated with the water collecting portion. The water outlet flow channel is at least partially formed on the back piece. The second circulation flow channel is communicated with each of the first circulation flow channel and the water outlet flow channel. The second circulation flow channel is at least partially formed on the right front piece.

Compared with the related art, the present disclosure has the following beneficial effects.

By means of the water collecting portion containing the cooling liquid and the pumping device promoting circulation of the cooling liquid along the path passing through the water collecting portion and the cooling flow channel, more heat can be quickly taken away during the process of the cooling liquid flowing through the cooling flow channel, achieving a fast and stable heat dissipation and cooling effect. A cooling capacity of the cooling garment is less affected by an environment, and the cooling garment can maintain efficient cooling performance even in high-temperature, windless, or high-humidity environments, thus improving the cooling effect.

By adopting the first cooling device including the water collecting portion, the cooling flow channel, and the pumping device, in combination with the second cooling device including the refrigeration device and the housing, the first cooling device can promote a circulation of the cooling liquid along the path passing through the water collecting portion and the cooling flow channel, effectively ensuring a coverage range of cooling and achieving continuous cooling, and the second cooling device can enable localized rapid and efficient cooling, strengthening a cooling intensity at key body parts. Thus, through a mutual cooperation and synergistic effect of the first cooling device and the second cooling device, dual-stage cooling may be formed, further improving the cooling effect, enabling efficient, continuous and comfortable cooling.

By adopting the garment body including the garment main body and the garment accessory, and by pressing the garment cooling flow channel on the garment main body and the accessory cooling flow channel on the garment accessory, the pumping device can promote the cooling liquid to circulate along the path passing through the water collecting portion, the accessory cooling flow channel, and the garment cooling flow channel. More heat can be quickly taken away during a process of the cooling liquid flowing through the accessory cooling flow channel and the garment cooling flow channel, achieving a fast and stable heat dissipation and cooling effect. Moreover, besides using the garment main body for cooling, the garment accessory can also be used for cooling, expanding a cooling range and achieving rapid and stable cooling over a wider range, significantly improving the wearer’s experience and further enhancing the cooling effect.

The collar includes the shapeable inner support, making a shape of the collar body adjustable, ensuring that the collar can closely contact the wearer’s skin, thereby optimizing heat transfer efficiency while enhancing wearing comfort and adaptability.

### BRIEF DESCRIPTION OF THE DRAWINGS

FIG. 1 is a structural view of a cooling garment according to an embodiment of the present disclosure.

FIG. 2 is a front view of an inner side of the cooling garment according to an embodiment of the present disclosure.

FIG. 3 is a structural view of a back of the cooling garment according to an embodiment of the present disclosure.

FIG. 4 is a structural view of an inner side of the back of the cooling garment according to an embodiment of the present disclosure.

FIG. 5 is a structural view of the cooling garment in a spread-out state according to an embodiment of the present disclosure.

FIG. 6 is a structural view of a second cooling device according to an embodiment of the present disclosure.

FIG. 7 is an exploded view of the second cooling device according to an embodiment of the present disclosure.

FIG. 8 is a structural view showing an engagement of a engaging protrusion and a slot according to an embodiment of the present disclosure.

FIG. 9 is a structural view showing an embedding protrusion embedded in a mounting groove according to an embodiment of the present disclosure.

FIG. 10 is a structural view of a fixing ring according to an embodiment of the present disclosure.

FIG. 11 is another exploded view of the second cooling device according to an embodiment of the present disclosure.

FIG. 12 is a structural view of an accessory portion according to an embodiment of the present disclosure.

FIG. 13 is a structural view of the accessory portion according to a second embodiment of the present disclosure.

FIG. 14 is a structural view of the cooling garment according to a third embodiment of the present disclosure.

FIG. 15 is a structural view of an inner side of a left front piece and an inner side of a right front piece of the cooling garment shown in FIG. 14.

FIG. 16 is a structural view of an inner side of a back piece of the cooling garment shown in FIG. 14.

FIG. 17 is a structural view of the cooling garment in the spread-out state shown in FIG. 14.

FIG. 18 is a structural view of a collar of the cooling garment shown in FIG. 14.

FIG. 19 is a structural view of the collar of the cooling garment shown in FIG. 14, where the collar is in a usage state.

FIG. 20 is a structural view of a shapeable inner support according to an embodiment of the present disclosure.

FIG. 21 is a structural view of the cooling garment according to a fourth embodiment of the present disclosure.

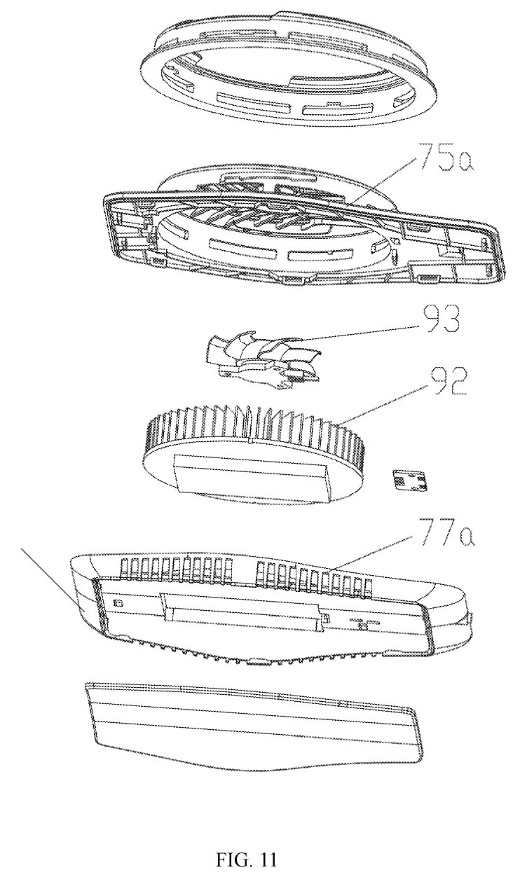

Reference numerals in FIGS. 11-13:

10. garment body; 11. back piece; 12. left front piece; 13. right front piece; 20. first cooling device; 30. water collecting portion; 40. cooling flow channel; 41. liquid inlet end; 42. liquid outlet end; 43. water inlet flow channel; 44. first circulation flow channel; 45. water outlet flow channel; 46. second circulation flow channel; 50. pumping device; 60. flow uniforming module; 61. water inlet flow uniforming member; 62. water outlet flow uniforming member; 70. second cooling device; 71. cold conducting member; 72. refrigeration device; 73. heat dissipation device; 74. base; 75. exhaust cover; 76. fixing ring; 77. embedding protrusion; 78. top peripheral edge; 79. inner protrusion; 80. first connecting member; 81. mounting groove; 82. passage region; 83. cavity; 84. heat dissipation fin; 90. second connecting member; 91. air intake portion; 92. heat sink; 93. heat dissipation fan; 94. through hole; 95. embedding groove; 96. engaging protrusion; 97. slot; 98. accommodating cavity; 100. accessory portion; 101. accessory flow channel section; 102. hat; 110. housing; 120. first connector; 130. second connector.

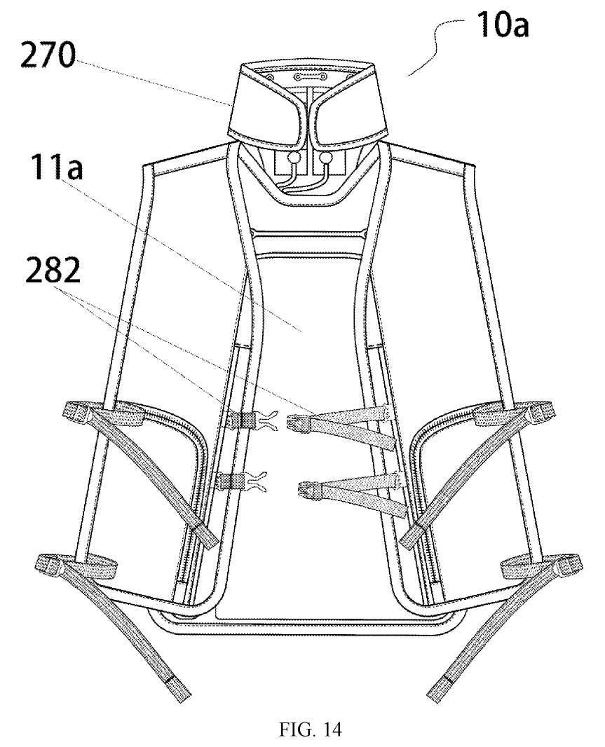

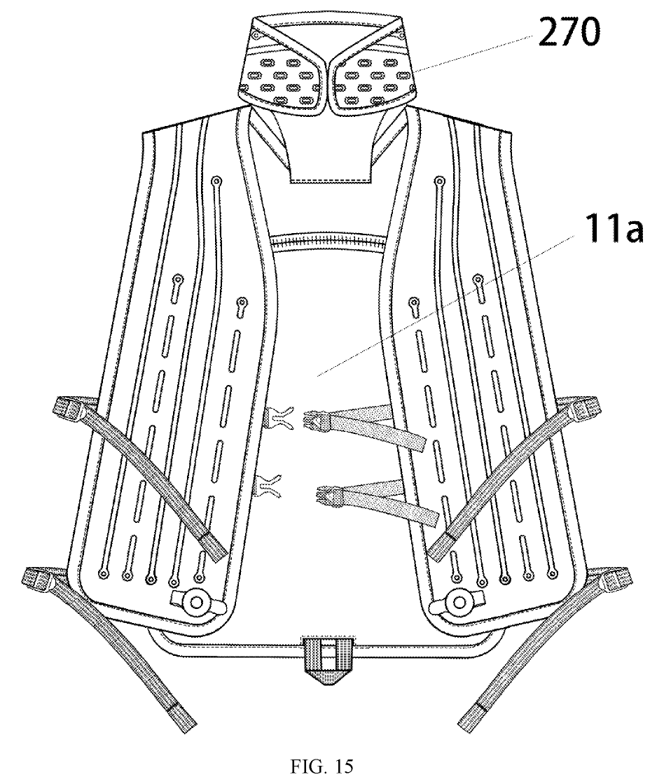

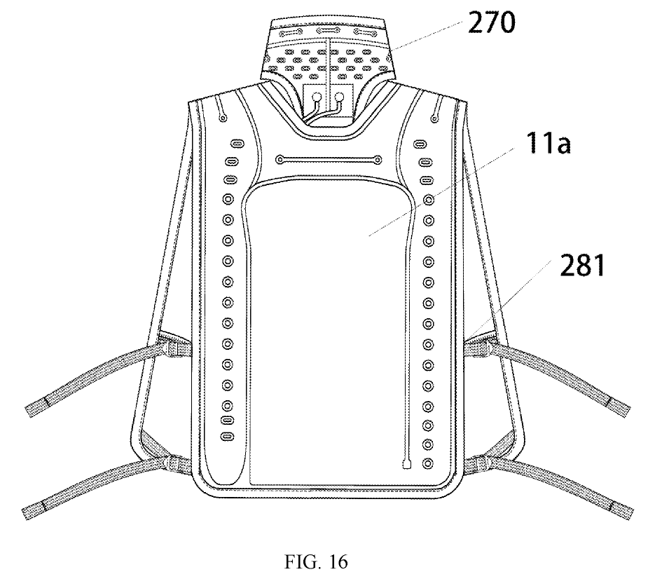

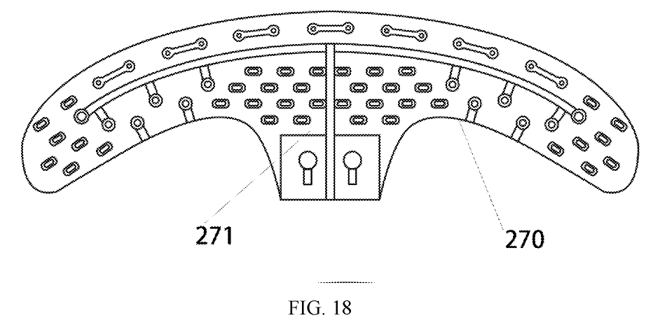

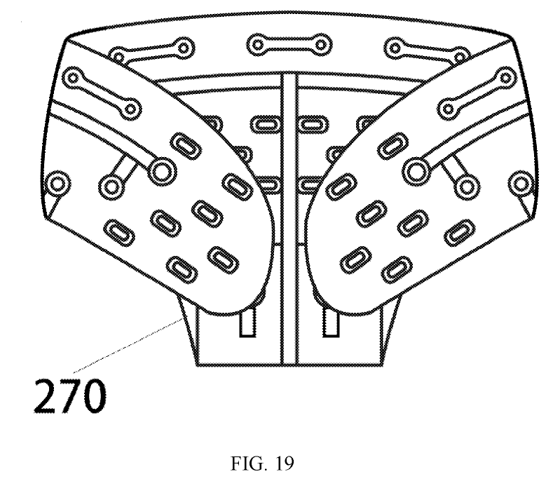

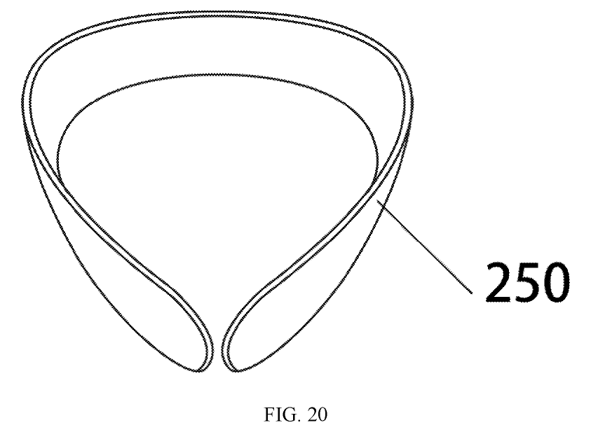

Reference numerals for FIGS. 14-21:

10a. garment body; 11a. back piece; 12a. left front piece; 13a. right front piece; 30a. water collecting portion; 40a. cooling flow channel; 41a. liquid inlet end; 42a. liquid outlet end; 43a. water inlet flow channel; 44a. first circulation flow channel; 45a. water outlet flow channel; 46a. second circulation flow channel; 50a. pumping device; 60a. flow uniforming module; 61a. water inlet flow uniforming member; 62a. water outlet flow uniforming member; 102a. hat; 210. garment main body; 220. water-cooling device; 240. garment cooling flow channel; 250. shapeable inner support; 270. garment accessory; 271. accessory cooling flow channel; 272. first communication pipe segment; 273. second communication pipe segment; 281. first connecting member; 282. second connecting member; 320. outlet connector; 330. water return connector.

### DETAILED DESCRIPTION

Hereinafter, the present disclosure will be further described with reference to the accompanying drawings and specific embodiments. It should be noted that, provided there is no conflict, various embodiments described below or various technical features can be arbitrarily combined to form new embodiments.

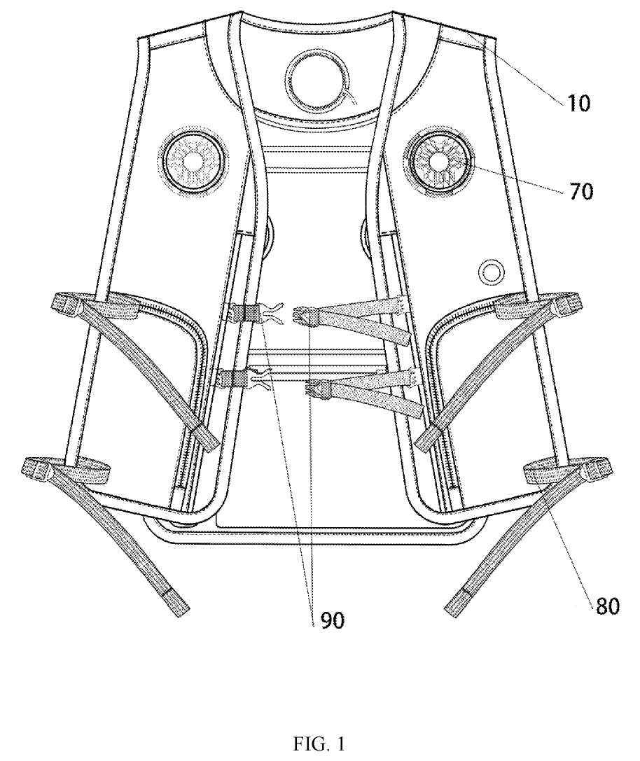

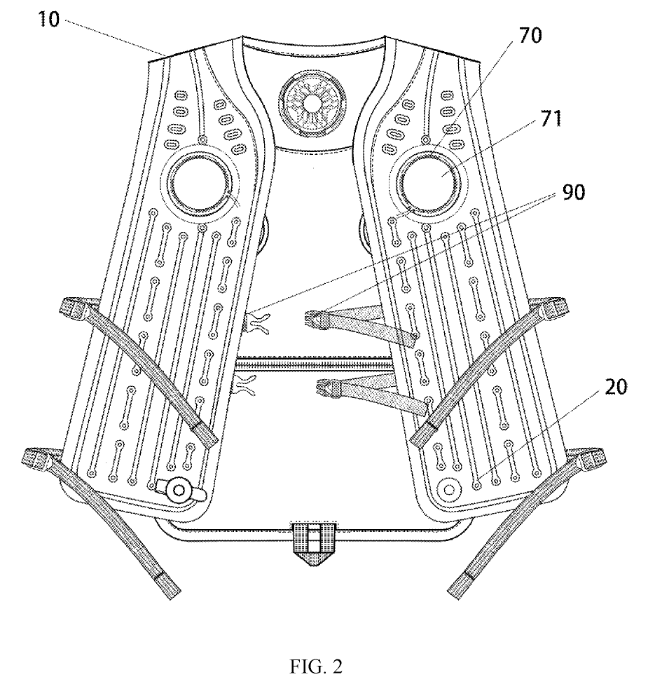

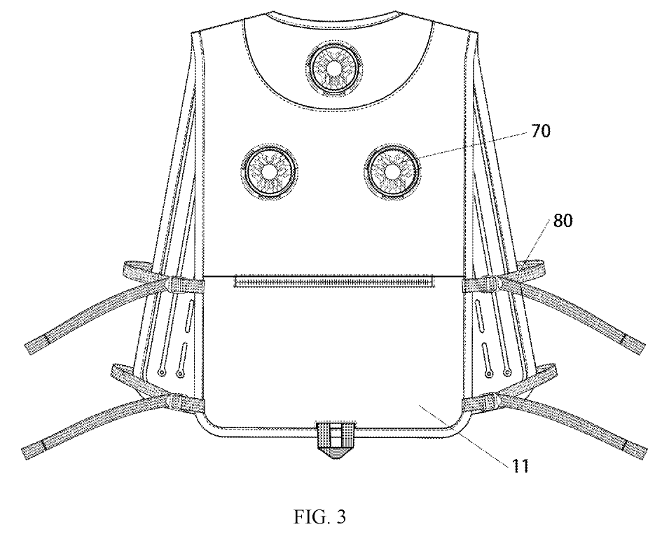

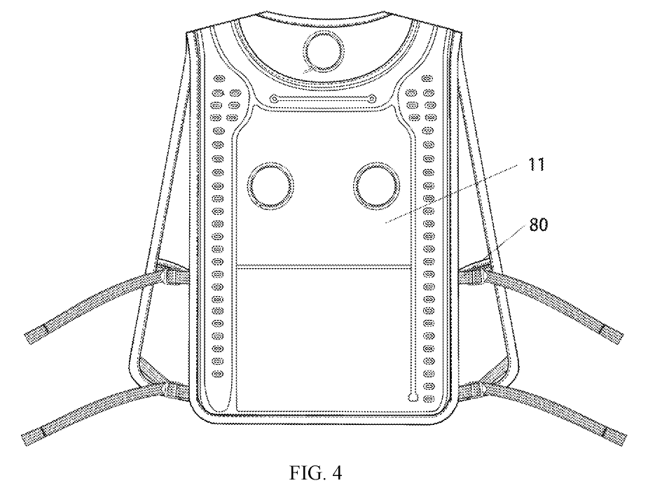

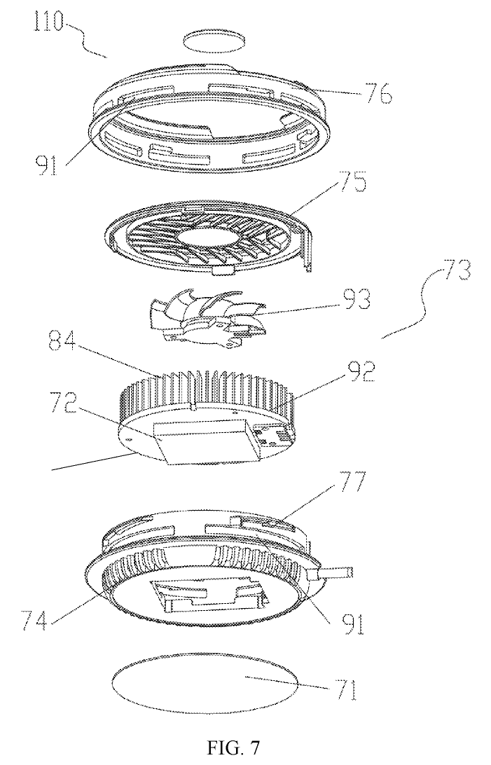

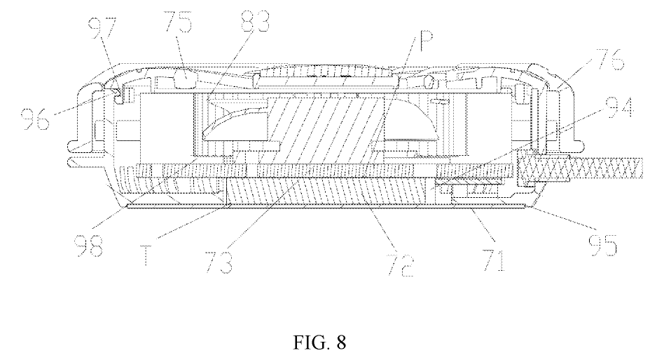

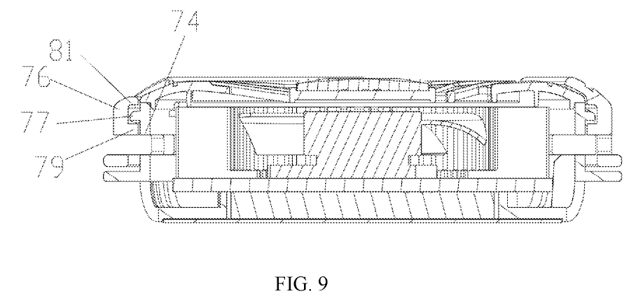

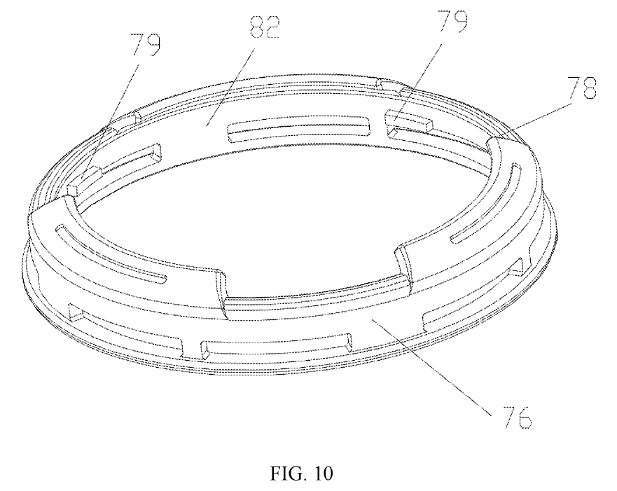

As shown in FIGS. 1-10, a cooling garment may include a garment body 10, a first cooling device 20, and a second cooling device 70. Each of the first cooling device 20 and the second cooling device 70 may be arranged on the garment body 10.

The first cooling device 20 may include a water collecting portion 30, a cooling flow channel 40, and a pumping device 50. The water collecting portion 30 may contain a cooling liquid. The cooling flow channel 40 may be used for the cooling liquid to flow through. The pumping device 50 may communicate the water collecting portion 30 and the cooling flow channel 40, and the pumping device 50 may promote the cooling liquid to circulate along a path passing through the water collecting portion 30 and the cooling flow channel 40. The cooling flow channel 40 may be formed on the garment body 10 by pressing for ease of manufacture.

The second cooling device 70 may include a refrigeration device 72 and a housing 110. The refrigeration device 72 may be arranged in the housing 110, and the refrigeration device 72 may be used for cooling.

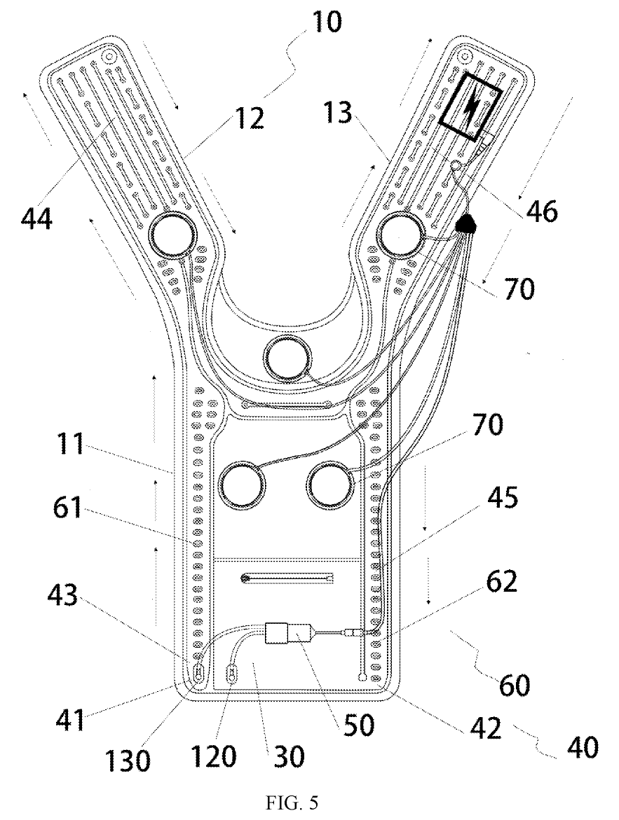

In use, with the pumping device 50 operating, the cooling liquid (e.g., water or other liquid) may circulate along the path passing through the water collecting portion 30 and the cooling flow channel 40 (in a path direction shown by arrows in FIG. 5), and can absorb the wearer’s body surface heat during a process of circulating through the cooling flow channel 40, achieving heat dissipation and cooling by means of water cooling. An area covered by the cooling flow channel 40 can ensure a water-cooling coverage range, maintaining a relatively cool a microenvironment on the wearer’s body surface. With the refrigeration device 72 operating, the refrigeration device 72 can dissipate heat and cool the wearer, achieving localized cooling. Therefore, the cooling garment provided in the present disclosure, by adopting the first cooling device 20 including the water collecting portion 30, the cooling flow channel 40, and the pumping device 50, may use the water collecting portion 30 to contain the cooling liquid and the pumping device 50 to promote the cooling liquid to circulate along the path passing through the water collecting portion 30 and the cooling flow channel 40, thereby quickly taking away more heat during the process of the cooling liquid flowing through the cooling flow channel 40, achieving a fast and stable heat dissipation and cooling effect. A cooling capacity of the cooling garment may be less affected by the environment, and the cooling garment can maintain efficient cooling performance even in high-temperature, windless, or high-humidity environments, thus improving the cooling effect. Moreover, based on the first cooling device 20 including the water collecting portion 30, the cooling flow channel 40, and the pumping device 50, and in combination with the second cooling device 70, the first cooling device 20 can promote the circulation of the cooling liquid along the path passing through the water collecting portion 30 and the cooling flow channel 40, effectively ensuring a sufficient water cooling coverage range, while the second cooling device 70 can enable localized cooling, strengthening a cooling intensity at key body parts of the wearer. Thus, through a mutual cooperation and synergistic effect of the first cooling device 20 and the second cooling device 70, dual cooling may be formed, further improving the cooling effect, enabling continuous and comfortable cooling. Furthermore, through the mutual cooperation and synergistic effect of the first cooling device 20 and the second cooling device 70, while effectively improving the cooling effect, a load on the second cooling device 70 can also be reduced.

The second cooling device 70 may further include a cold conducting member 71 and a heat dissipation device 73. The housing 110 may include a base 74, an exhaust cover 75, and a fixing ring 76. The exhaust cover 75 may cover the base 74, and a receiving cavity 98 may be formed between the exhaust cover 75 and the base 74. The base 74 may be arranged with an embedding protrusion 77. The fixing ring 76 may sleeve an outer side of the exhaust cover 75, the fixing ring 76 may be arranged with a top peripheral edge 78, and the fixing ring 76 may be circumferentially arranged with a plurality of inner protrusions 79. A mounting groove 81 for embedding the embedding protrusion 77 may be formed between each inner protrusion 79 and the top peripheral edge 78. A passage region 82 for the embedding protrusion 77 to pass through may be formed between each two adjacent inner protrusions 79. The heat dissipation device 73 may be arranged in the receiving cavity 98. One end of the refrigeration device 72 may be formed as a refrigerating end, and the other end of the refrigeration device 72 may be formed as a heat dissipating end. The heat dissipation device 73 may cooperate with the heat dissipating end P of the refrigeration device 72. The cold conducting member 71 may cooperate with the refrigerating end T of the refrigeration device 72. Each of the base 74 and the fixing ring 76 may define an air intake portion 91. Specifically, the air intake portion 91 may be an air intake hole, an air intake slot, or the like.

In use, the cold conducting member 71 may be in contact with the wearer. With the refrigeration device 72 operating, heat dissipated by the human body may be transferred via the cold conducting member 71 to the refrigerating end and may be absorbed by the refrigerating end. The heat may be transferred from the refrigerating end to the heat dissipating end and then dissipated via the heat dissipation device 73. Thus, the second cooling device 70 can enable rapid and powerful localized cooling, efficiently removing core body heat.

During an assembly process of the second cooling device 70, after the cold conducting member 71, refrigeration device 72, heat dissipation device 73, base 74, and exhaust cover 75 are assembled, each embedding protrusion 77 of the base 74 may be aligned with the passage region 82, and the fixing ring 76 may sleeve the outer side of the exhaust cover 75. Then, the fixing ring 76 may be rotated so that the embedding protrusion 77 may enter the mounting groove 81. This arrangement can facilitate mounting between the fixing ring 76 and the base 74.

The base 74 may define a through hole 94 and an embedding groove 95, the through hole 94 may be communicated with the receiving cavity 98. The refrigeration device 72 may be inserted in the through hole 94. The embedding groove 95 may be communicated with the through hole 94 and may extend through an end of the base 74 away from the exhaust cover 75. The cold conducting member 71 may be embedded in the embedding groove 95, and an end of the cold conducting member 71 away from the refrigeration device 72 may be exposed from the base 74. In use, the cold conducting member 71 may be exposed and can directly contact the human body. The above arrangement can facilitate assembly.

One of the exhaust cover 75 and the base 74 may be circumferentially arranged with a plurality of engaging protrusions 96, and the other of the exhaust cover 75 and the base 74 may circumferentially define a plurality of slots 97. The engaging protrusions 96 may be engaged in the slots 97 respectively. That is, when the exhaust cover 75 is circumferentially arranged with the plurality of engaging protrusions 96, then the base 74 may circumferentially define the plurality of slots 97 for respectively engaging the plurality of engaging protrusions 96; when the base 74 is circumferentially arranged with the plurality of engaging protrusions 96, then the exhaust cover 75 may circumferentially define the plurality of slots 97 for respectively engaging the plurality of engaging protrusions 96. In use, the fixing ring 76 may sleeve the outer side of the exhaust cover 75 and abut against the exhaust cover 75. Moreover, the mounting between the exhaust cover 75 and the base 74 may be achieved by engagements of the plurality of engaging protrusions 96 in the plurality of slots 97, improving stability of an assembly of the exhaust cover 75.

The refrigeration device 72 may include a refrigeration sheet. After the refrigeration sheet is powered on, the heat dissipated by the human body may be transferred via the cold conducting member 71 to the refrigerating end. The heat absorbed by the refrigerating end may be moved to the heat dissipating end, causing a temperature of the refrigerating end to decrease and a temperature of the heat dissipating end to increase, and then the heat may be dissipated via the heat dissipation device 73. Specifically, the refrigeration sheet may be a TEC semiconductor refrigeration sheet or the like.

The heat dissipation device 73 may include a heat sink 92 and a heat dissipation fan 93. The heat sink 92 may define a cavity 83, and the heat dissipation fan 93 may be arranged in the cavity 83. When the heat dissipation fan 93 operates, the heat dissipation fan 93 can promote airflow to enter from the air intake portion 91, flow through the cavity 83, and then be exhausted from the exhaust cover 75. Heat from the heat dissipating end of the refrigeration device 72 may be transferred to the heat sink 92, and the airflow passing through the cavity 83 can quickly carry away the heat, which may be then exhausted through the exhaust cover 75, thereby effectively improving heat dissipation efficiency.

The heat sink 92 may include a seat 921 and a plurality of heat dissipation fins 84 circumferentially arranged on the seat 921. The seat 921 may abut against the heat dissipating end of the refrigeration device 72. The use of the heat dissipation fins 84 can increase a heat dissipation area, further optimizing the heat dissipation effect.

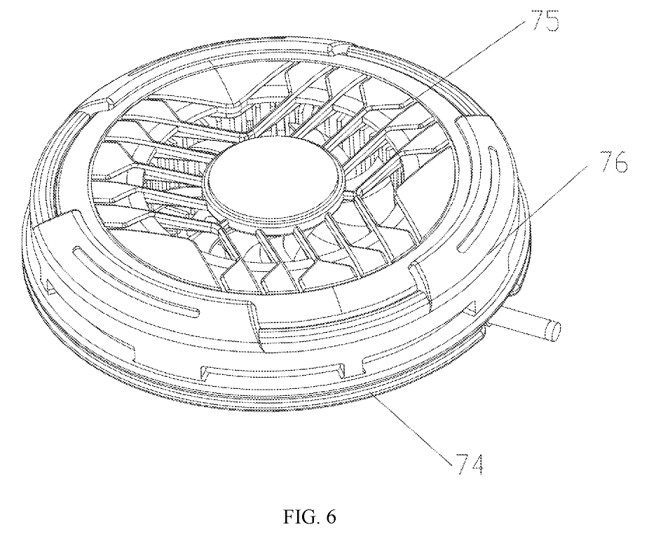

Shapes of the base 74 and the exhaust cover 75 can be arranged according to actual needs. For example, as shown in FIG. 6, each of the base 74 and the exhaust cover 75 may be cylindrical; or, as shown in FIG. 11, the base 74a and the exhaust cover 75a may be irregularly shaped.

The garment body 10 may include a back piece 11, a left front piece 12, and a right front piece 13. An upper end of the left front piece 12 may be arranged on one side of the back piece 11, and an upper end of the right front piece 13 may be arranged on the other side of the back piece 11. This arrangement of the garment body 10 can reduce a manufacturing cost of the garment body 10 and can facilitate wearing by a user and user movement.

In some embodiments, the back piece 11 and the left front piece 12 may be connected with each other via a first connecting member 80, and the back piece 11 and the right front piece 13 may be connected with each other via the first connecting member 80. The left front piece 12 and the right front piece 13 may be connected with each other via a second connecting member 90. Each of the first connecting member 80 and the second connecting member 90 may include existing connecting members such as a connecting buckle or a hook and loop fastener.

Each of the back piece 11, the left front piece 12, and the right front piece 13 may be arranged with the second cooling device 70, so as to cool the wearer’s back, left front, and right front respectively via the second cooling devices 70 on the back piece 11, the left front piece 12, and the right front piece 13.

The cooling flow channel 40 may have a liquid inlet end 41 and a liquid outlet end 42. The liquid inlet end 41 of the cooling flow channel 40 may be communicated with the pumping device 50, and the liquid outlet end 42 of the cooling flow channel 40 may be communicated with the water collecting portion 30. The pumping device 50 may include a water pump, a water inlet end of the water pump may be communicated with the water collecting portion 30, and a water outlet end of the water pump may be communicated with the liquid inlet end 41 of the cooling flow channel 40. When the water pump operates, the cooling liquid may flow from the water collecting portion 30 through the water pump to the liquid inlet end 41 of the cooling flow channel 40, flow through the cooling flow channel 40, and then flow from the liquid outlet end 42 of the cooling flow channel 40 to the water collecting portion 30. Then, the cooling liquid may flow from the water collecting portion 30 through the water pump to the cooling flow channel 40 and then flow back from the cooling flow channel 40 to the water collecting portion 30, thus continuously circulating in the above manner, achieving a sustained cooling and heat dissipation effect.

The cooling flow channel 40 may include a water inlet flow channel 43 and a first circulation flow channel 44. The water inlet flow channel 43 may be communicated with the pumping device 50. The water inlet flow channel 43 may be at least partially formed on the back piece 11, the first circulation flow channel 44 may be communicated with the water inlet flow channel 43, and the first circulation flow channel 44 may be at least partially formed on the left front piece 12. The cooling flow channel 40 may further include a water outlet flow channel 45 and a second circulation flow channel 46. The water outlet flow channel 45 may be communicated with the water collecting portion 30. The water outlet flow channel 45 may be at least partially formed on the back piece 11, the second circulation flow channel 46 may be communicated with each of the first circulation flow channel 44 and the water outlet flow channel 45, and the second circulation flow channel 46 may be at least partially formed on the right front piece 13. When the water pump operates, the cooling liquid may flow from the water collecting portion 30 through the water pump into the water inlet flow channel 43, flow through the first circulation flow channel 44 to the second circulation flow channel 46, and then flow back to the water collecting portion 30 via the water outlet flow channel 45, then flow from the water collecting portion 30 through the water pump to the water inlet flow channel 43, thus continuously circulating in the above manner. An end of the water inlet flow channel 43 away from the first circulation flow channel 44 may be formed as the liquid inlet end 41, and the end of the water outlet flow channel 45 away from the second circulation flow channel 46 may be formed as the liquid outlet end 42. Adopting the above arrangement can optimize the liquid flow path and cooling coverage area, allowing the cooling liquid to flow through main torso areas such as the front side and the back, forming a complete circulation path and achieving more uniform cooling of the torso.

The cooling flow channel 40 may include garment cooling flow channels. The garment cooling flow channels may include the water inlet flow channel 43 and the first circulation flow channel 44. The garment cooling flow channels may also include the water outlet flow channel 45 and the second circulation flow channel 46.

The cooling flow channel 40 may be arranged with a flow uniforming module 60 for the cooling liquid to flow past. The flow uniforming module 60 may include a plurality of water inlet flow uniforming members 61. The plurality of water inlet flow uniforming members 61 may be arranged sequentially at intervals in the water inlet flow channel 43. The water inlet flow uniforming member 61 may have a circular cross-section. When the cooling liquid flows through the water inlet flow channel 43, the water inlet flow uniforming members 61 arranged in the water inlet flow channel 43 can disperse and disturb the flow of the cooling liquid. The cooling liquid may flow past the water inlet flow uniforming members 61. Guided by each water inlet flow uniforming member 61, the cooling liquid flowing past each water inlet flow uniforming member 61 can become uniform, dispersed, and stable. Moreover, as the cooling liquid may flow past the water inlet flow uniforming members 61, a heat exchange time of the cooling liquid can be prolonged, allowing sufficient heat exchange, thereby further improving the cooling effect.

In some embodiments, the flow uniforming module 60 may include a plurality of water outlet flow uniforming member 62. The plurality of water outlet flow uniforming members 62 may be arranged sequentially at intervals in the water outlet flow channel 45 along an extending trajectory of the water outlet flow channel 45. The water outlet flow uniforming member 62 may have a circular cross-section. When the cooling liquid flows through the water outlet flow channel 45, the cooling liquid may flow past the water outlet flow uniforming members 62. The cooling liquid flowing past each water outlet flow uniforming member 62 may become uniform, dispersed, and stable, and a heat exchange time of the cooling liquid may be prolonged for sufficient heat exchange.

To further optimize performance of the cooling garment, the flow uniforming module 60 may also include flow uniforming portions as described above respectively arranged in the first circulation flow channel 44 and the second circulation flow channel 46. These flow uniforming portions can serve to make the cooling liquid flowing through the first circulation flow channel 44 and the second circulation flow channel 46 uniform and dispersed, and allow the cooling liquid to flow through, further prolonging the heat exchange time of the cooling liquid.

A water inlet end of the water pump may be arranged with a first connector 120 which may be connected with the water collecting portion 30. A water outlet end of the water pump may be arranged with a second connector 130 which may be connected with the cooling flow channel 40. Each of the first connector 120 and the second connector 130 may be any existing connector on the market, such as a flexible joint.

The water collecting portion 30 may be a water bag, a water collecting container, a water collecting cavity, or the like that may serve to collect water. An ice pack may be arranged inside the water collecting portion 30 to cool the cooling liquid within the water collecting portion 30 so that the cooling liquid can remain continuously at a low temperature.

The garment body 10 may be of a structure of any existing garment body on the market. For example, the garment body 10 may include several layers. The cooling flow channel 40 may be formed on the layers by pressing. In some embodiments, the garment body 10 may be formed with an outer layer, an inner layer, an insulating layer, and a working layer. The outer layer, inner layer, insulating layer, and working layer may be arranged sequentially. Each of the cooling flow channel 40 and the water collecting portion 30 may be formed on the working layer. The working layer may be a unitary material formed by laminating (e.g., adhesively laminating) various layers together. For example, the working layer may be formed by pressing together two layers of gel (e.g., silicone) that have recesses for the flow channels. The water pump may be arranged according to actual needs, for example, on the inner layer.

The cold conducting member 71 may be an existing cold conducting member, as long as heat from various areas of the human body can be transferred via the cold conducting member 71 to the refrigerating end of the refrigeration sheet, such as a cold conducting plate, an aluminum plate, or the like.

An actual working principle of the present disclosure may be as follows. During use, the water pump operates, driving the cooling liquid to circulate through the cooling flow channel 40. As the liquid flows through the flow channels on the left front piece 12, right front piece 13, and back piece 11, the liquid can uniformly absorb heat from the wearer’s front torso and back, achieving mild cooling over a relatively wide area.

Simultaneously, the refrigeration sheets of the second cooling devices 70 on the left front piece 12, the right front piece 13, and the back piece 11 may be powered on. Heat from various areas of the human body may be transferred via the cold conducting members 71 to the refrigerating ends of the refrigeration sheets and may be absorbed by the refrigerating ends, achieving second-stage localized rapid and efficient cooling. The heat absorbed by the refrigerating ends may be moved from the refrigerating ends to the heat dissipating ends, conducted through the heat dissipating ends to the heat sinks 92, and taken away by the airflow blown out by the heat dissipation fans 93, then exhausted through the exhaust covers 75. Through a synergistic work of the first cooling device 20 and the second cooling devices 70, the first cooling device 20 may provide continuous basic heat dissipation, while the second cooling devices 70 can provide powerful localized cooling, together achieving efficient, lasting, and comfortable dual-stage cooling.

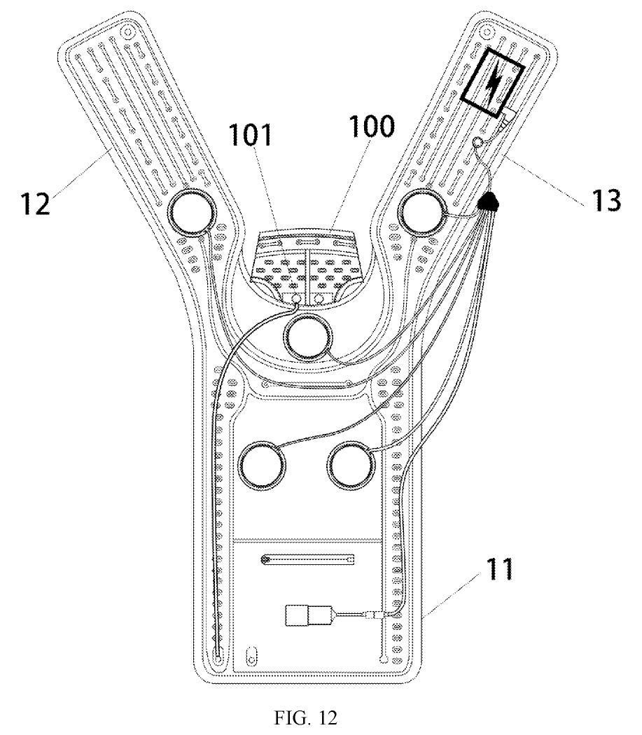

FIG. 12 is a structural view of the cooling garment according to a second embodiment of the present disclosure. A difference from FIG. 1 may be only that in the cooling garment shown in FIG. 12, the garment body 10 may further include an accessory portion 100. The cooling flow channel 40 may be at least partially formed on the accessory portion 100. As the cooling liquid flows through a portion of the cooling flow channel 40 formed on the accessory portion 100, the accessory portion 100 can cool the wearer, further increasing a cooling range.

Specifically, the water inlet flow channel 43 may include an accessory flow channel section 101 formed on the accessory portion 100, and the accessory flow channel section 101 may be communicated with the water outlet end of the water pump. When the water pump operates, the cooling liquid may flow from the water collecting portion 30 through the water pump into the accessory flow channel section 101 and then flow through a remaining part of the water inlet flow channel 43 to the first circulation flow channel 44. The accessory flow channel section 101 may be a curved flow channel section distributed over the entire accessory portion 100, or a multi-segment flow channel section, etc., according to actual needs.

The accessory portion 100 may be independently arranged according to actual needs, or may be arranged on the back piece 11, or on the left front piece 12 and the right front piece 13, etc.

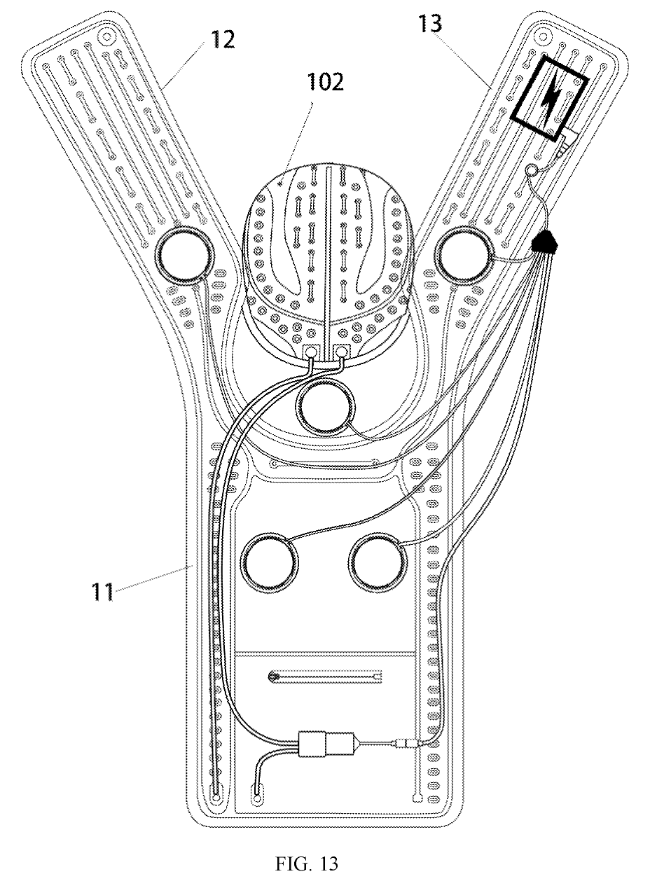

The accessory portion 100 may be a collar or a neck scarf or may be a hat 102 as shown in FIG. 13.

FIGS. 14-20 show a third embodiment of the cooling garment provided in the present disclosure. As shown in FIGS. 14-20, in the third embodiment, the cooling garment may include a garment body 10a and a water-cooling device 220.

The water-cooling device 220 may include a water collecting portion 30a, a cooling flow channel 40a, and a pumping device 50a. The water collecting portion 30a may be used for containing a cooling liquid.

The garment body 10a may include a garment main body 210 and a garment accessory 270. The cooling flow channel 40a may include a garment cooling flow channel 240 and an accessory cooling flow channel 271.

The garment cooling flow channel 240 may be formed on the garment main body 210 by pressing, and the garment cooling flow channel 240 may be used for the cooling liquid to flow through.

The accessory cooling flow channel 271 may be formed on the garment accessory 270 by pressing, and the accessory cooling flow channel 271 may be used for the cooling liquid to flow through.

The pumping device 50a can promote the cooling liquid to circulate along a path passing through the water collecting portion 30a and the cooling flow channel, i.e., the pumping device 50a can promote the cooling liquid to circulate along a path passing through the water collecting portion 30a, the accessory cooling flow channel 271, and the garment cooling flow channel 240.

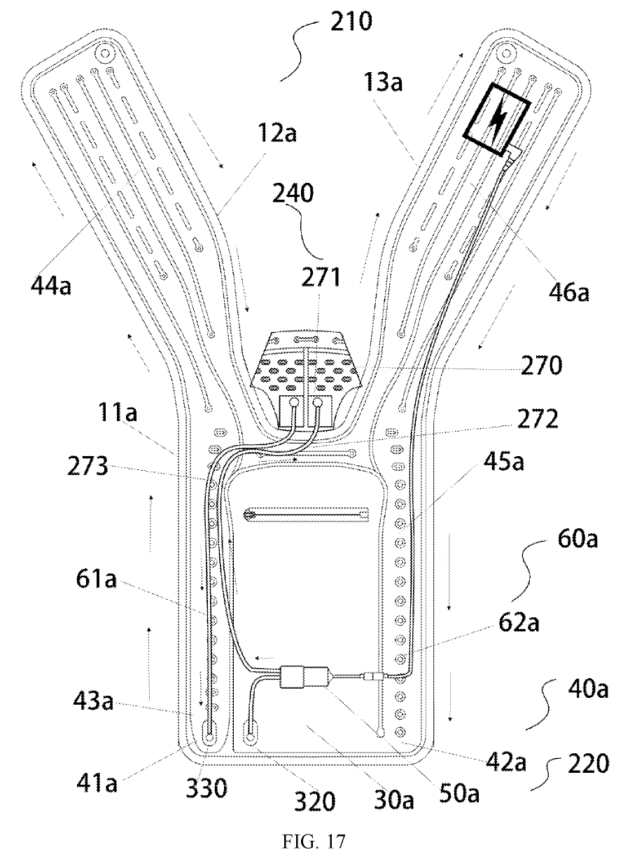

In use, with the pumping device 50a operating, the cooling liquid (e.g., water or other liquid) may circulate along the path passing through the water collecting portion 30a, the accessory cooling flow channel 271, and the garment cooling flow channel 240 (in a direction shown by arrows in FIG. 17). During a process of circulating through the accessory cooling flow channel 271 and the garment cooling flow channel 240, the cooling liquid an absorb human body heat, achieving heat dissipation and cooling by means of water cooling. The accessory cooling flow channel 271 and the garment cooling flow channel 240 can increase a water cooling coverage range, thereby expanding a cooling range and maintaining a relatively cool body surface microenvironment. Therefore, the cooling garment of this embodiment, by adopting a combination of the garment body 10a and the water-cooling device 220, and based on the water-cooling device 220 including the water collecting portion 30a, the cooling flow channel 40a, and the pumping device 50a, and by pressing the garment cooling flow channel 240 on the garment main body 210 and the accessory cooling flow channel 271 on the garment accessory 270, uses the pumping device 50a to promote the cooling liquid to circulate along the path passing through the water collecting portion 30a, the accessory cooling flow channel 271, and the garment cooling flow channel 240. More heat may be quickly taken away during the process of the cooling liquid flowing through the accessory cooling flow channel 271 and the garment cooling flow channel 240, achieving a fast and stable heat dissipation and cooling effect. A cooling capacity of the cooling garment may be less affected by the environment, and the cooling garment can maintain efficient cooling performance even in high-temperature, windless, or high-humidity environments. Moreover, besides the garment main body 210, the garment accessory 270 can also be used for cooling, expanding the cooling range and achieving rapid and stable cooling over a wider range, significantly improving the wearer’s experience.

The garment accessory 270 may be a collar, so that targeted cooling of the wearer’s neck may be achieved through the collar.

The collar may include a collar body and a shapeable inner support 250. The accessory cooling flow channel 271 may be formed in the collar body. The shapeable inner support 250 may be arranged on the collar body and can deform under an external force to adjust a shape of the collar body. This arrangement can allow the user to manually adjust the shape of the collar according to their own neck shape and comfort needs, ensuring that the collar can closely contact the wearer’s skin, thereby improving cooling efficiency and wearing comfort.

The shapeable inner support 250 may be made of an existing shapeable material such as shapeable silicone, shapeable plastic, memory alloy, etc., as long as the shapeable inner support 250 can undergo plastic deformation under the external force to adjust the shape of the collar body.

The accessory cooling flow channel 271 may be communicated with a water outlet end of the pumping device 50a. The garment cooling flow channel 240 may be communicated with each of the accessory cooling flow channel 271 and the water collecting portion 30a. The water collecting portion 30a may be communicated with a water inlet end of the pumping device 50a. When the pumping device 50a operates, the cooling liquid may flow from the water collecting portion 30a through the pumping device 50a to the accessory cooling flow channel 271, flow through the garment cooling flow channel 240, and then flow to the water collecting portion 30a, then flow from the water collecting portion 30a through the pumping device 50a to the accessory cooling flow channel 271, thus continuously circulating in the above manner, achieving a sustained cooling and heat dissipation effect.

The accessory cooling flow channel 271 may be communicated with the water outlet end of the pumping device 50a via a first communication pipe segment 272. The accessory cooling flow channel 271 may be communicated with the garment cooling flow channel 240 via a second communication pipe segment 273. When the pumping device 50a operates, the cooling liquid may flow from the water outlet end of the pumping device 50a through the first communication pipe segment 272 to the accessory cooling flow channel 271, flow through the accessory cooling flow channel 271, and then flow through the second communication pipe segment 273 to the garment cooling flow channel 240. Each of the first communication pipe segment 272 and the second communication pipe segment 273 may be any existing communication pipe segment on the market, for example, a soft, kink-resistant silicone tube.

The pumping device 50a may include a water pump. The water outlet end of the water pump may be arranged with an outlet connector 320 which may be connected with the first communication pipe segment 272. The second communication pipe segment 273 may be arranged with a water return connector 330 which may be connected with the water collecting portion 30a. Specifically, the outlet connector 320 and the water return connector 330 may be any existing joint on the market. Particularly, each of the outlet connector 320 and the water return connector 330 may be a flexible joint.

In some embodiments, the water-cooling device 220 may be arranged on the garment main body 210.

The garment main body 210 may include a back piece 11a, a left front piece 12a, and a right front piece 13a. An upper end of the left front piece 12a may be arranged on one side of the back piece 11a, and an upper end of the right front piece 13a may be arranged on the other side of the back piece 11a. This arrangement of the garment main body 210 can reduce a manufacturing cost of the garment main body 210 and facilitate wearing and movement.

In some embodiments, the back piece 11a and the left front piece 12a may be connected with each other via a first connecting member 281, and the back piece 11a and the right front piece 13a may be connected with each other via the first connecting member 281. The left front piece 12a and the right front piece 13a may be connected with each other via a second connecting member 282. Each of the first connecting member 281 and the second connecting member 282 may include an existing connecting member such as a connecting buckle or a hook and loop fastener.

The garment cooling flow channel 240 may have a liquid inlet end 41a and a liquid outlet end 42a. The liquid inlet end 41a of the garment cooling flow channel 240 may be communicated with the second communication pipe segment 273, and the liquid outlet end 42a of the garment cooling flow channel 240 may be communicated with the water collecting portion 30a.

The garment cooling flow channel 240 may include a water inlet flow channel 43a and a first circulation flow channel 44a. The water inlet flow channel 43a may be communicated with the accessory cooling flow channel 271 via the second communication pipe segment 273. The water inlet flow channel 43a may be at least partially formed on the back piece 11a, the first circulation flow channel 44a may be communicated with the water inlet flow channel 43a, and the first circulation flow channel 44a may be at least partially formed on the left front piece 12a. The garment cooling flow channel 240 may include a water outlet flow channel 45a and a second circulation flow channel 46a. The water outlet flow channel 45a may be communicated with the water collecting portion 30a. The water outlet flow channel 45a may be at least partially formed on the back piece 11a. The second circulation flow channel 46a may be communicated with each of the first circulation flow channel 44a and the water outlet flow channel 45a. The second circulation flow channel 46a may be at least partially formed on the right front piece 13a. An end of the water inlet flow channel 43a away from the first circulation flow channel 44a may be formed as the liquid inlet end 41a, and an end of the water outlet flow channel 45a away from the second circulation flow channel 46a may be formed as the liquid outlet end 42a.

The cooling flow channel 40a may be arranged with a flow uniforming module 60a for the cooling liquid to flow past. Specifically, the garment cooling flow channel 240 may be arranged with the flow uniforming module 60a for the cooling liquid to flow past. The flow uniforming module 60a may include a plurality of water inlet flow uniforming members 61a. The plurality of water inlet flow uniforming members 61a may be arranged sequentially at intervals in the water inlet flow channel 43a. The water inlet flow uniforming member 61a may have a circular cross-section. When the cooling liquid flows through the water inlet flow channel 43a, the water inlet flow uniforming members 61a arranged inside disperse and disturb the flow of the cooling liquid. The cooling liquid may flow past the water inlet flow uniforming members 61a. Guided by each water inlet flow uniforming member 61a, the cooling liquid flowing past each water inlet flow uniforming member 61a may become uniform, dispersed, and stable. Moreover, as the cooling liquid flows past the water inlet flow uniforming members 61a, a heat exchange time of the cooling liquid may be prolonged, allowing sufficient heat exchange, thereby further improving the cooling effect.

In some embodiments, the flow uniforming module 60a may include a plurality of water outlet flow uniforming members 62a. The water outlet flow channel 45a may be arranged with the plurality of water outlet flow uniforming members 62a arranged sequentially at intervals along an extending trajectory of the water outlet flow channel 45a. The water outlet flow uniforming member 62a may have a circular cross-section. When the cooling liquid flows through the water outlet flow channel 45a, the cooling liquid may flow past the water outlet flow uniforming members 62a. The cooling liquid flowing past each water outlet flow uniforming member 62a may become uniform, dispersed, and stable, and the heat exchange time of the cooling liquid may be prolonged for sufficient heat exchange.

To further optimize the performance of the cooling garment, the flow uniforming module 60a may also include flow uniforming portions respectively arranged in the first circulation flow channel 44a and the second circulation flow channel 46a. These flow uniforming portions described above can serve to make the cooling liquid flowing through the first circulation flow channel 44a and the second circulation flow channel 46a uniform and dispersed, and allow the cooling liquid to flow through, further prolonging the heat exchange time of the cooling liquid.

The water collecting portion 30a may be a water bag, a water collecting container, a water collecting cavity, or the like that may serve to collect water. An ice pack may be arranged inside the water collecting portion 30a to cool the cooling liquid within the water collecting portion 30a so that the cooling liquid can remain continuously at a low temperature.

The garment cooling flow channel 240 may be formed on the garment main body 210 by pressing. The accessory cooling flow channel 271 may be formed on the garment accessory 270 by pressing, for ease of manufacture.

The garment main body 210 may be of a structure of any existing garment main body on the market. For example, the garment main body 210 may include several layers. The garment cooling flow channel 240 can be formed on the structural layers by pressing. For example, the garment main body 210 may be formed with an outer layer, an inner layer, an insulating layer, and a working layer. The outer layer, inner layer, insulating layer, and working layer may be arranged sequentially. Each of the garment cooling flow channel 240 and the water collecting portion 30a may be formed on the working layer. The working layer may be a unitary material formed by laminating (e.g., adhesively laminating) various layers together. For example, the working layer may be formed by pressing together two layers of gel (e.g., silicone) that have recesses for the garment flow channels. The garment cooling flow channel 240 may be formed by pressing and sealing the two layers of gel (e.g., silicone). The water pump may be arranged according to actual needs, for example, on the inner layer.

Similarly, the garment accessory 270 may be of a structure of any existing garment accessory on the market. For example, the garment accessory 270 may include several layers. The accessory cooling flow channel 271 may be formed on the layers by pressing. For example, a collar body of the garment accessory 270 may include a facing layer, an insulating layer, a base layer, etc. The accessory cooling flow channel 271 may be formed on the base layer. The base layer may be a unitary material formed by laminating (e.g., adhesively laminating) various layers together. For example, the base layer may be formed by pressing together two layers of gel (e.g., silicone) that have recesses for the accessory flow channels. The accessory cooling flow channel 271 may be formed by pressing and sealing the two layers of gel (e.g., silicone) together.

In actual design, the garment accessory 270 may be integrally manufactured with the garment main body 210 as a one-piece structure as needed, or the garment accessory 270 and the garment main body 210 may be detachably connected with each other via connecting components such as a hook-and-loop fastener, or the garment accessory 270 and the garment main body 210 may be arranged separately.

An actual working principle of the cooling garment of this embodiment may be as follows. The water collecting portion 30a may be filled with a cooling liquid (such as cold water or a phase change material solution). The wearer may put on the garment main body 210 and the garment accessory 270. When the water pump is on, the cooling liquid may flow from the water collecting portion 30a through the water pump and the first communication pipe segment 272 into the accessory cooling flow channel 271, and then flow through the second communication pipe segment 273 to the water inlet flow channel 43a, through the first circulation flow channel 44a to the second circulation flow channel 46a, and then back to the water collecting portion 30a via the water outlet flow channel 45a. Then, the cooling liquid may flow from the water collecting portion 30a through the water pump and the first communication pipe segment 272 into the accessory cooling flow channel 271, thus continuously circulating in the above manner. During this process, the cooling liquid may flow through the accessory cooling flow channel 271 of the garment accessory 270 and the garment cooling flow channel 240 of the garment main body 210, continuously absorbing and removing heat from the wearer’s torso and areas covered by the garment accessory 270, thereby achieving efficient and more comprehensive active cooling.

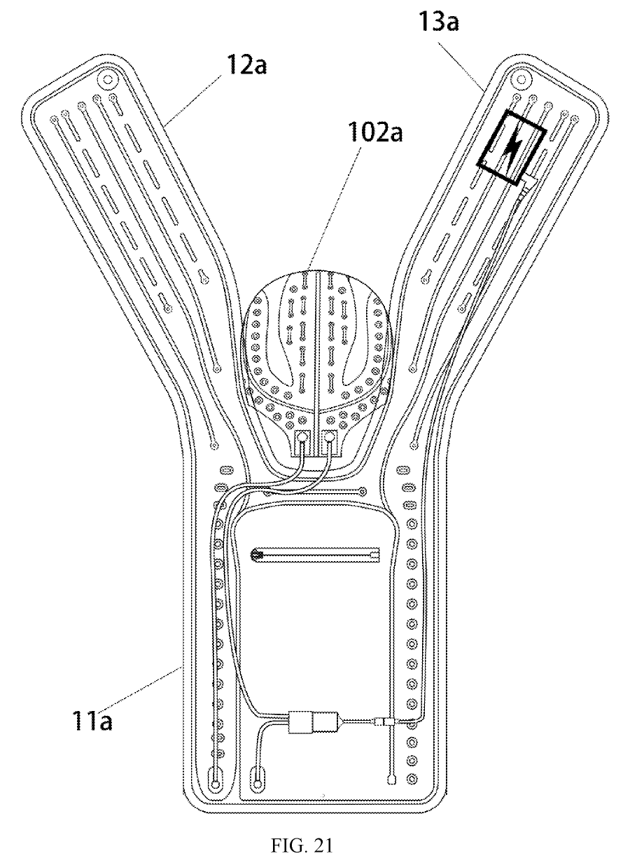

FIG. 21 shows a fourth embodiment of the cooling garment. A difference from FIG. 14 may be only the garment accessory 270. In the fourth embodiment, the garment accessory 270 may be a hat 102a, so that targeted cooling of the wearer’s head may be achieved through the hat 102a.

The above embodiments are only preferred embodiments of the present disclosure and are not intended to limit the scope of protection of the present disclosure. Any non-substantial changes or substitutions made by those skilled in the art on the basis of the present disclosure fall within the scope of protection required by the present disclosure.

What is claimed is:

1. A cooling garment, comprising:
a garment body,
a first cooling device, arranged on the garment body and comprising a water collecting portion, a cooling flow channel, and a pumping device; wherein the water collecting portion is configured to contain a cooling liquid; the cooling flow channel is formed on the garment body by pressing and configured for the cooling liquid to flow through; the pumping device communicates the water collecting portion and the cooling flow channel, and the pumping device is configured to promote the cooling liquid to circulate along a path passing through the water collecting portion and the cooling flow channel; and
a second cooling device, arranged on the garment body and comprising a refrigeration device and a housing; wherein the refrigeration device is arranged in the housing and configured for cooling.

2. The cooling garment as claimed in claim 1, wherein the second cooling device further comprises a cold conducting member and a heat dissipation device; the housing comprises a base, an exhaust cover, and a fixing ring; the exhaust cover covers the base, and a receiving cavity is formed between the exhaust cover and the base; the base is arranged with an embedding protrusion, the fixing ring sleeves an outer side of the exhaust cover, the fixing ring has a top peripheral edge, and the fixing ring is circumferentially arranged with a plurality of inner protrusions; a mounting groove for embedding the embedding protrusion is formed between the top peripheral edge and each of the plurality of inner protrusions; a passage region for the embedding protrusion to pass through is formed between each two adjacent inner protrusions of the plurality of inner protrusions;
the heat dissipation device is arranged in the receiving cavity, one end of the refrigeration device is formed as a refrigerating end, and the other end of the refrigeration device is formed as a heat dissipating end; the heat dissipation device is cooperated with the heat dissipating end of the refrigeration device; the cold conducting member is cooperated with the refrigerating end of the refrigeration device; each of the base and the fixing ring is formed with an air intake portion.

3. The cooling garment as claimed in claim 2, wherein the base defines a through hole and an embedding groove, and the through hole is communicated with the receiving cavity; the refrigeration device is arranged in the through hole; the embedding groove is communicated with the through hole and extends through the base to an end of the base away from the exhaust cover; the cold conducting member is embedded in the embedding groove, and an end of the cold conducting member away from the refrigeration device is exposed from the base.

4. The cooling garment as claimed in claim 2, wherein one of the exhaust cover and the base is circumferentially arranged with a plurality of engaging protrusions, and the other of the exhaust cover and the base circumferentially defines a plurality of slots; each of the plurality of engaging protrusions is engaged in a respective one of the plurality of slots.

5. The cooling garment as claimed in claim 2, wherein the refrigeration device comprises a refrigeration sheet; the heat dissipation device comprises a heat sink and a heat dissipation fan; the heat sink defines a cavity, and the heat dissipation fan is arranged in the cavity.

6. The cooling garment as claimed in claim 5, wherein the heat sink comprises a seat and a plurality of heat dissipation fins circumferentially arranged on the seat; the seat abuts against the heat dissipating end of the refrigeration device.

7. The cooling garment as claimed in claim 1, wherein the cooling flow channel comprises a liquid inlet end and a liquid outlet end; the liquid inlet end of the cooling flow channel is communicated with the pumping device, and the liquid outlet end of the cooling flow channel is communicated with the water collecting portion;
the pumping device comprises a water pump, a water inlet end of the water pump is communicated with the water collecting portion, and a water outlet end of the water pump is communicated with the liquid inlet end of the cooling flow channel.

8. The cooling garment as claimed in claim 7, wherein the water inlet end of the water pump is arranged with a first connector configured to be connected with the water collecting portion; the water outlet end of the water pump is arranged with a second connector configured to be connected with the cooling flow channel.

9. The cooling garment as claimed in claim 1, wherein the garment body comprises a back piece, a left front piece, and a right front piece; an upper end of the left front piece is arranged on one side of the back piece, and an upper end of the right front piece is arranged on the other side of the back piece.

10. The cooling garment as claimed in claim 9, wherein the cooling flow channel comprises a water inlet flow channel and a first circulation flow channel; the water inlet flow channel is communicated with the pumping device; the water inlet flow channel is at least partially formed on the back piece, the first circulation flow channel is communicated with the water inlet flow channel, and the first circulation flow channel is at least partially formed on the left front piece.

11. The cooling garment as claimed in claim 10, wherein the cooling flow channel is arranged with a flow uniforming module configured for the cooling liquid to flow past; the flow uniforming module comprises a plurality of water inlet flow uniforming members; the plurality of water inlet flow uniforming members are arranged sequentially at intervals in the water inlet flow channel; at least one of the water inlet flow uniforming members has a circular cross-section;
the cooling flow channel comprises a water outlet flow channel and a second circulation flow channel; the water outlet flow channel is communicated with the water collecting portion; the water outlet flow channel is at least partially formed on the back piece, the second circulation flow channel is communicated with each of the first circulation flow channel and the water outlet flow channel, and the second circulation flow channel is at least partially formed on the right front piece.

12. The cooling garment as claimed in claim 9, wherein the garment body further comprises an accessory portion, and the cooling flow channel is at least partially formed on the accessory portion.

13. A cooling garment, comprising:
a garment body, comprising a garment main body and a garment accessory; and
a water-cooling device, comprising a water collecting portion, a cooling flow channel, and a pumping device; wherein the water collecting portion is configured to contain a cooling liquid; the pumping device is configured to promote the cooling liquid to circulate along a path passing through the water collecting portion and the cooling flow channel; the cooling flow channel comprises a garment cooling flow channel and an accessory cooling flow channel; the garment cooling flow channel is formed on the garment main body by pressing, and the garment cooling flow channel is configured for the cooling liquid to flow through; the accessory cooling flow channel is formed on the garment accessory by pressing, and the accessory cooling flow channel is configured for the cooling liquid to flow through.

14. The cooling garment as claimed in claim 13, wherein the garment accessory is a collar, and the collar comprises a collar body and a shapeable inner support; the accessory cooling flow channel is formed on the collar body; the shapeable inner support is arranged on the collar body and is configured to deform under an external force to adjust a shape of the collar body.

15. The cooling garment as claimed in claim 13, wherein the accessory cooling flow channel is communicated with a water outlet end of the pumping device; the garment cooling flow channel is communicated with each of the accessory cooling flow channel and the water collecting portion; the water collecting portion is communicated with a water inlet end of the pumping device.

16. The cooling garment as claimed in claim 15, wherein the accessory cooling flow channel is communicated with a water outlet end of the pumping device via a first communication pipe segment; the accessory cooling flow channel is communicated with the garment cooling flow channel via a second communication pipe segment.

17. The cooling garment as claimed in claim 16, wherein the pumping device comprises a water pump; a water outlet end of the water pump is arranged with an outlet connector configured to be communicated with the first communication pipe segment; the second communication pipe segment is arranged with a water return connector configured to be communicated with the water collecting portion.

18. The cooling garment as claimed in claim 13, wherein the garment main body comprises a back piece, a left front piece, and a right front piece; an upper end of the left front piece is arranged on one side of the back piece, and an upper end of the right front piece is arranged on the other side of the back piece.

19. The cooling garment as claimed in claim 18, wherein the garment cooling flow channel comprises a water inlet flow channel and a first circulation flow channel; the water inlet flow channel is at least partially formed on the back piece, the first circulation flow channel is communicated with the water inlet flow channel, and the first circulation flow channel is at least partially formed on the left front piece.

20. The cooling garment as claimed in claim 19, wherein the cooling flow channel is arranged with a flow uniforming module configured for the cooling liquid to flow past; the flow uniforming module comprises a plurality of water inlet flow uniforming members; the plurality of water inlet flow uniforming members are arranged sequentially at intervals in the water inlet flow channel; at least one of the water inlet flow uniforming member has a circular cross-section;
the garment cooling flow channel comprises a water outlet flow channel and a second circulation flow channel; the water outlet flow channel is communicated with the water collecting portion; the water outlet flow channel is at least partially formed on the back piece; the second circulation flow channel is communicated with each of the first circulation flow channel and the water outlet flow channel; the second circulation flow channel is at least partially formed on the right front piece.
